(19) United States
(12) Patent Application Publication
(10) Pub. No.: US 2026/0288498 A1
(43) Pub. Date: Sep. 24, 2026

(54) Method and Apparatus for Providing a Proactive Recommendation Message of a Digital Assistant of a Vehicle to the Driver of the Vehicle

(71) Applicant: Bayerische Motoren Werke Aktiengesellschaft, Muenchen (DE)

(72) Inventor: Mathias Ordung, Muenchen (DE)

(21) Appl. No.: 19/132,114

(22) PCT Filed: Aug. 16, 2023
(86) PCT No.: PCT/EP2023/072502

§ 371 Date: May 22, 2025

(30) Foreign Application Priority Data
Nov. 29, 2022 (DE) 10 2022 131 646.7

(51) Int. Cl. G06F 9/451; G07C 5/02

(52) U.S. Cl. CPC G06F 9/453; G07C 5/02

(57) ABSTRACT

A method provides a proactive recommendation message of a digital assistant of a vehicle to a driver of a vehicle. The method includes receiving an operating interaction between the driver and a software application of the vehicle, an identifier of the driver, and a multiplicity of items of context information of the vehicle at a time-point of the operating interaction. A server also facilitates ascertaining, using the operating interaction, the frequency with which the driver operates the software application. The method also includes determining a usage scenario of the vehicle in dependence on the frequency with which the user of the vehicle operates the software application, and on the multiplicity of items of context information. The method further includes providing the driver, through the server, with the proactive recommendation message of the digital assistant in dependence on the determined usage scenario of the vehicle, using the digital assistant.

The present application is the U.S. national phase of PCT Application PCT/EP2023/072502 filed on Aug. 16, 2023, which claims priority of German patent application No. 10 2022 131 646.7 filed on Nov. 29, 2022, the entire contents of which are incorporated herein by reference.

### TECHNICAL FIELD

The disclosure relates to the field of vehicles, and more particularly, to providing a proactive recommendation message of a digital assistant of a vehicle to a driver of the vehicle.

### BACKGROUND

In vehicles, digital assistants are known that can execute commands from a user of the vehicle. For this purpose, the user of the vehicle can activate the digital assistant and then send a command to execute a function, or a question, to the digital assistant. The digital assistant can perform the corresponding function and provide a response to the user of the vehicle. Proactive provision of messages by the digital assistant of the vehicle is often not provided, and not possible, in order not to distract a driver of the vehicle from a driving task and/or unnecessarily disturb or interrupt a user of the vehicle.

There exists a need to efficiently provide a proactive recommendation message of a digital assistant of the vehicle to a user of the vehicle. There exists a further need to provide a proactive recommendation message of a digital assistant more precisely to a driver of the vehicle without distracting the driver of the vehicle.

### SUMMARY

The above-described needs, as well as others, are addressed by at least some embodiments disclosed herein.

A first aspect is characterized by a method for providing a proactive recommendation message of a digital assistant of a vehicle to a driver of the vehicle. The method may be a computer-implemented method and/or a method implemented by a control device. The proactive recommendation message may be a proactive dialogue message of the digital assistant of the vehicle, in which case the proactive dialogue message may include a recommendation, appropriate to a usage scenario of the vehicle, to a driver of the vehicle. The digital assistant of the vehicle may be a cloud-based digital assistant. The digital assistant may be controlled via various operating modalities, for example voice-based, touch-based, and/or gesture-based. The vehicle may be a motor vehicle or a motorcycle.

The method comprises receiving an operating interaction between the driver of the vehicle and a software application of the vehicle, an identifier of the driver of the vehicle, and a multiplicity of items of context information of the vehicle at a time-point of the operating interaction between the user of the vehicle and the software application of the vehicle, through an external server. The method further comprises ascertaining, using the received operating interaction between the driver of the vehicle and the software application of the vehicle, the frequency with which the driver operates the software application of the vehicle, through the vehicle-external server, and determining a usage scenario of the vehicle from a predefined quantity of usage scenarios in dependence on the frequency with which the user of the vehicle operates the software application, and on the multiplicity of items of context information of the vehicle, through the vehicle-external server. The method further comprises providing the driver Of the vehicle, through the vehicle-external server, with the proactive recommendation message of the digital assistant in dependence on the determined usage scenario of the vehicle, by means of the digital assistant of the vehicle.

In some implementations, the method may provide a proactive recommendation message appropriate to a determined usage scenario in an efficient and automated manner. The digital assistant of the vehicle may thus, in dependence on the usage scenario of the vehicle, provide the driver with a recommendation that is more specific to the situation. The method means that the driver of the vehicle is less distracted from the driving task. Furthermore, the vehicle adapts to the usage scenario, in that appropriate proactive recommendation messages are provided by the digital assistant. Manual configuration and/or explicit accessing of software applications and/or functions of software applications of the vehicle can thus be reduced. Moreover, the driver may also learn unknown functions and unknown software applications of the vehicle in the respective usage scenario, and thus learn how to operate the functions and/or software applications of the vehicle correctly according to the situation.

According to some designs, the method may further comprise determining, through the vehicle-external server, an item of life-cycle information in dependence on the identifier of the driver of the vehicle and an identifier of the vehicle, wherein the item of life-cycle information is preferably representative of a frequency and/or a duration of a usage of the vehicle by the driver of the vehicle, and wherein the usage scenario of the vehicle is determined, through the vehicle-external server, from the predefined quantity of usage scenarios in dependence on the frequency with which the user of the vehicle operates the software application, the multiplicity of items of context information of the vehicle, and from the item of life-cycle information. For example, the item of life-cycle information may include a number of journeys with the vehicle that are made by the driver of the vehicle. For example, the item of life-cycle information may include an item of time information that is representative of a length of time that the driver of the vehicle owns and/or drives the vehicle as a vehicle owner. In other words, the items of life-cycle information may be representative of a macro situation describing a relationship of the driver with the vehicle. This allows the usage scenario to be determined in an efficient and personalized manner in dependence on the item of life-cycle information between the driver and the vehicle.

According to some embodiments, the method may include, of the multiplicity of items of context information, an item of context information that is representative Of a situation in an interior of the vehicle, and the item of context information that is representative of the situation in the interior of the vehicle may preferably include an occupancy of seats of the vehicle, an item of information relating to an emotional state of the driver of the vehicle, and/or an item of information relating to a time and/or distance to a destination. This allows the usage scenario of the vehicle, and thus the proactive recommendation message of the digital assistant of the vehicle, to be determined more efficiently.

According to some implementations, an item of context information from the multiplicity of items of context information may be representative of a state of the vehicle, and the item of context information that is representative of the state of the vehicle may preferably include a charge state, a fuel-level state, a driving state and/or a parking state of the vehicle. This allows the usage scenario of the vehicle, and thus the proactive recommendation message of the digital assistant of the vehicle, to be determined more efficiently.

According to some embodiments, an item of context information from the multiplicity of items of context information may be representative of an item of information relating to weather in the vicinity of the vehicle. This allows the usage scenario of the vehicle, and thus the proactive recommendation message of the digital assistant of the vehicle, to be determined more efficiently.

According to some designs, a usage scenario from the predefined multiplicity of usage scenarios may include one or more recommendations pertaining to one or more software applications of the vehicle. This allows a plurality of recommendations pertaining to a usage scenario to be provided to the driver of the vehicle with greater precision.

According to some implementations, a recommendation pertaining to a software application of the vehicle of a usage scenario from the predefined multiplicity of usage scenarios may be representative of frequencies with which users, in particular drivers, of a fleet of vehicles of a vehicle manufacturer operate software applications. This allows a recommendation pertaining to a usage scenario to be determined in an efficient manner.

According to some embodiments, the determined usage scenario of the vehicle may be linked to a confidence interval, wherein the confidence interval indicates the certainty with which the usage scenario has been determined in dependence on the frequency with which the user of the vehicle operates the software application and on the multiplicity of items of context information of the vehicle, and the proactive recommendation message of the digital assistant may be provided to the driver of the vehicle only if a lower limit of the confidence interval Of the determined usage scenario exceeds a minimum confidence threshold. This allows the proactive recommendation message to be provided to the driver of the vehicle with a greater degree of accuracy.

According to some implementations, the proactive recommendation message may include one or the plurality of recommendations pertaining to one or more software applications of the determined usage scenario, and/or the proactive recommendation message may include the determined usage scenario and the confidence interval of the determined usage scenario. This allows explanations to be efficiently provided to the user as to why the recommendations are proactively provided to the driver of the vehicle. The driver can thus more easily understand a reason for the recommendation message. Distraction of the driver from a driving task can be efficiently reduced.

A further aspect is characterized by a computer-readable medium for providing a proactive recommendation message of a digital assistant of a vehicle to a driver of the vehicle, wherein the computer-readable medium comprises instructions that, when executed on a computer, perform the method described above.

A further aspect is characterized by a system for providing a proactive recommendation message of a digital assistant of a vehicle to a driver of the vehicle, wherein the system is designed to perform the method described above.

A further aspect is characterized by a vehicle comprising the system, described above, for providing a proactive recommendation message of a digital assistant of a vehicle to a driver of the vehicle.

Further features are apparent from the claims, the FIGURE and the FIGURE description. All the aforementioned features and combinations of features mentioned in the description, as well as the features and combinations of features mentioned below in the description of the FIGURE and/or shown only in the FIGURE, can be utilized not only in the combination indicated in each case, but also in other combinations or, alternatively, on their own.

### BRIEF DESCRIPTION OF THE DRAWING FIGURE

FIG. 1 shows schematically an example of a method for providing a proactive recommendation message of a digital assistant of a vehicle to a driver of the vehicle.

### DETAILED DESCRIPTION

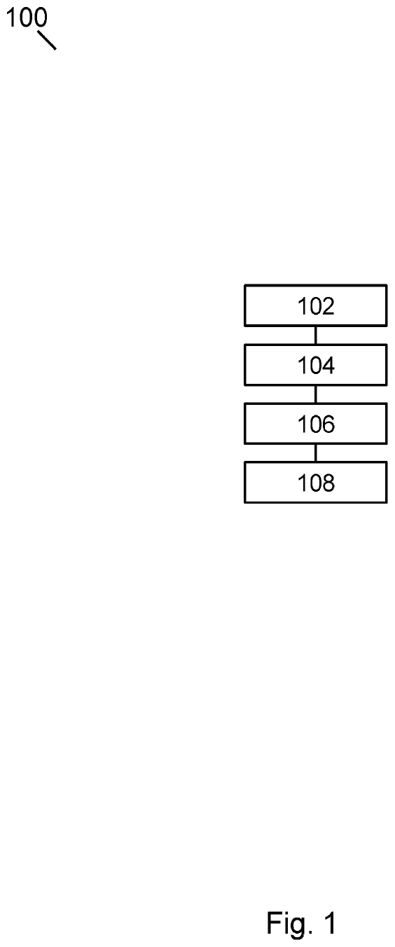

FIG. 1 shows in detail an example of a method 100 for providing a proactive recommendation message of a digital assistant of a vehicle to a driver of the vehicle. The proactive recommendation message may be a recommendation message proactively provided by the digital assistant of the vehicle to the driver of the vehicle or to another user of the vehicle. The proactive recommendation message may include one or a plurality of recommendations. Preferably, the proactive recommendation message is a message provided visually on a display device of the vehicle by the digital assistant of the vehicle. Additionally or alternatively, the proactive recommendation message may be a voice message from the vehicle digital assistant of the vehicle to the driver or to another user of the vehicle.

The digital assistant of the vehicle may be a cloud-based digital assistant of the vehicle. The cloud-based digital assistant may comprise a dialogue control application that is executed on a cloud-based server. Further, the cloud-based digital assistant may use one or more output devices, for example one or more display devices and/or one or more loudspeakers, of the vehicle in order to provide the proactive recommendation message, preferably generated by the dialogue control application of the digital assistant, to the driver of the vehicle.

The method may receive 102, through a vehicle-external server, an operating interaction between the driver of the vehicle and a software application of the vehicle, an identifier of the driver of the vehicle, and/or a multiplicity of items of context information of the vehicle at a time-point of the operating interaction between the user of the vehicle and the software application of the vehicle. In addition, the method may receive an identifier of the vehicle, for example a vehicle identification number. The software application of the vehicle may be an app of the vehicle. For example, the software application may be a navigation app, an audio streaming app, a telephony app, an instant messaging app, or another app that can be executed on the infotainment system of the vehicle. The multiplicity of items of context information may be representative of a driving situation, an environment situation, and/or a state of the vehicle at the time-point of the operating interaction. For example, an item of context information from the multiplicity of items of context information may be representative a charging state, a fuel-level state, a driving state and/or a parking state of the vehicle. The driving state may indicate, for example, that the driver is currently on their daily commute to work, on a route to a regular leisure activity, on an excursion or on a vacation journey. For example, an item of context information of the multiplicity of items of context information may be representative of a situation in the interior of the vehicle. The item of context information that is representative of the situation in the interior of the vehicle may include an occupancy of seats of the vehicle, an item of information relating to an emotional state of the driver of the vehicle, and/or an item of information relating to a time and/or distance to a destination. Further, an item of context information from the multiplicity of items of context information may be representative of an item of information relating to weather in the vicinity of the vehicle.

The method 100 may further ascertain 104, through the vehicle-external server, using the received operating interaction between the driver of the vehicle and the software application of the vehicle, a frequency with which the driver operates the software application of the vehicle. The method may ascertain a frequency of operation for each software application of the vehicle, and for each driver of the vehicle. For example, the driver of the vehicle may be identified by means of the received identifier of the driver of the vehicle.

The method 100 may determine 106, through the vehicle-external server, a usage scenario of the vehicle from a predefined quantity of usage scenarios in dependence on the frequency with which the user of the vehicle operates the software application, and on the multiplicity of items of context information of the vehicle. The predefined quantity of usage scenarios may include typical, known usage scenarios of vehicles. Examples of usage scenarios from the predefined quantity of usage scenarios of vehicles may be: driving on a commute, driving to a vacation, driving to a leisure activity, driving for shopping, driving to an official appointment, driving to a private appointment, charging, charging in sunshine, charging in rain, parking, parking in a public parking lot, and/or parking in a private parking lot. The predefined quantity of usage scenarios may include a predefined maximum number of the most frequent usage scenarios of vehicles. For example, the predefined quantity of usage scenarios may include the most frequent 10, 20, 30, 40, 50, 60, . . . usage scenarios of vehicles. Each usage scenario from the predefined quantity of usage scenarios may include a quantity of software applications of the vehicle, in particular apps of the vehicle, that are most frequently used in the usage scenario. The quantity of software applications of a usage scenario may be ascertained using the frequencies with which all drivers or some drivers of a vehicle fleet operate the software applications. Preferably, the quantity of software applications of a usage scenario is ascertained using the frequencies with which all drivers of a vehicle fleet operate the software applications. A sequence of software applications of a usage scenario may be ascertained in dependence on the frequencies with which all drivers or some drivers of a vehicle fleet operate the software applications. For example, a software application that has the highest frequency of operation may be in a first position in the quantity of software applications of the usage scenario, and a software application that has the second highest frequency of operation may be in a second position in the quantity of software applications of the usage scenario. The quantity of software applications may include the n-highest frequency of operation of software applications. For example, the quantity of software applications may comprise three software applications that each have the highest frequencies of operation in the usage scenario.

If a software application is in the quantity of software applications of a usage scenario, the digital assistant of the vehicle may add a recommendation to the proactive recommendation message, pertaining to this software application. For example, the recommendation may include a dialogue regarding use of the software application in the usage scenario. The digital assistant may add recommendations to the proactive recommendation message, pertaining to all software applications or to some software applications from the quantity of software applications of the usage scenario. For example, the digital assistant may add a recommendation to the proactive recommendation message, pertaining to a software application from the quantity of software applications in the usage scenario, in dependence on an item of context information, such as an item of information relating to weather.

The method may provide, through the vehicle-external server, an item of life-cycle information in dependence on the identifier of the driver of the vehicle and an identifier of the vehicle. The item of life-cycle information may be representative of a relationship between the driver and the vehicle. For example, the item of life-cycle information may be representative of a frequency and/or a duration of use of the vehicle by the driver of the vehicle. If the driver of the vehicle uses the vehicle for the first time or if the driver drives the vehicle for the first few times, for example the first 10 journeys with the vehicle, this item of information may be used to determine the usage scenario. In detail, the usage scenario of the vehicle may be determined, through the vehicle-external server, from the predefined quantity of usage scenarios in dependence on the frequency with which the user of the vehicle operates the software application, the multiplicity of items of context information of the vehicle, and from the item of life-cycle information.

The method 100 may provide 108, through the vehicle-external server, the proactive recommendation message of the digital assistant to the driver of the vehicle, in dependence on the determined usage scenario of the vehicle, by means of the digital assistant of the vehicle. The proactive recommendation message may include the usage scenario and one or a plurality of recommendations relating to the usage scenario. If determining the usage scenario includes an estimate of the usage scenario in dependence on the items of context information, the proactive recommendation message may additionally include a probability with which the usage scenario has been determined.

Advantageously, the method can efficiently assess a vehicle situation using items of context information from the vehicle. The digital assistant may thus provide a proactive recommendation message to the driver of the vehicle that is matched to the situation of the situation. Distraction of the driver from the driving situation thereby be efficiently reduced and/or avoided. Depending on the usage scenario, the driver of the vehicle may receive appropriate proactive recommendations pertaining to the software applications of the vehicle. The vehicle-external server receives only items of context information relating to a current vehicle situation. It is not necessary for data from sensors to be transmitted to the vehicle-external server in order to determine a usage scenario of the vehicle and recommendations for the usage scenario. Recommendations pertaining to software applications with respect to a usage scenario can thus be provided with greater precision to the driver of the vehicle by the digital assistant of the vehicle.

### LIST OF REFERENCE DESIGNATIONS

100 Method
102 Receiving an operating interaction
104 Ascertaining a frequency of operation
106 Determining a usage scenario
108 Providing a proactive recommendation message

1.-12. (canceled)

13. A method for providing a proactive recommendation message of a digital assistant of a vehicle to a driver of the vehicle, the method comprising:
receiving an operating interaction between the driver of the vehicle and a software application of the vehicle, an identifier of the driver of the vehicle, and a multiplicity of items of context information of the vehicle at a time-point of the operating interaction between the driver of the vehicle and the software application of the vehicle, through a vehicle-external server;
ascertaining, using the operating interaction between the driver of the vehicle and the software application of the vehicle, the frequency with which the driver operates the software application of the vehicle, through the vehicle-external server;
determining a usage scenario of the vehicle from a predefined quantity of usage scenarios in dependence on the frequency with which the user of the vehicle operates the software application, and on the multiplicity of items of context information of the vehicle, through the vehicle-external server; and
providing the driver of the vehicle, through the vehicle-external server, with the proactive recommendation message of the digital assistant in dependence on the determined usage scenario of the vehicle, by means of the digital assistant of the vehicle.

14. The method as claimed in claim 13, further comprising:
determining, through the vehicle-external server, an item of life-cycle information in dependence on the identifier of the driver of the vehicle and an identifier of the vehicle, wherein the item of life-cycle information relates to a usage of the vehicle by the driver of the vehicle; and
wherein the usage scenario of the vehicle is determined, through the vehicle-external server, from the predefined quantity of usage scenarios in dependence on the frequency with which the user of the vehicle operates the software application, the multiplicity of items of context information of the vehicle, and the item of life-cycle information.

15. The method as claimed in claim 14, wherein the item of life-cycle information is at least one of the group consisting of a frequency of the usage of the vehicle by the driver of the vehicle, and a duration of the usage of the vehicle by the driver of the vehicle.

16. The method as claimed in claim 14, wherein an item of context information of the multiplicity of items of context information is representative of a situation in an interior of the vehicle; and
wherein the item of context information that is representative of the situation in the interior of the vehicle includes at least one of the group consisting of an occupancy of seats of the vehicle, an item of information relating to an emotional state of the driver of the vehicle, and an item of information relating to a time or distance to a destination.

17. The method as claimed in claim 16, wherein a further item of context information from the multiplicity of items of context information is representative of a state of the vehicle; and
wherein the further item of context information that is representative of the state of the vehicle includes at least one of the group consisting of a charge state, a fuel-level state, a driving state, and a parking state.

18. The method as claimed in claim 17, wherein an item of context information from the multiplicity of items of context information is representative of an item of information relating to weather in a vicinity of the vehicle.

19. The method as claimed in claim 13, wherein an item of context information of the multiplicity of items of context information is representative of a situation in an interior of the vehicle; and
wherein the item of context information that is representative of the situation in the interior of the vehicle includes at least one of the group consisting of an occupancy of seats of the vehicle, an item of information relating to an emotional state of the driver of the vehicle, and an item of information relating to a time or distance to a destination.

20. The method as claimed in claim 13, wherein an item of context information from the multiplicity of items of context information is representative of a state of the vehicle; and
wherein the item of context information that is representative of the state of the vehicle includes at least one of the group consisting of a charge state, a fuel-level state, a driving state, and a parking state.

21. The method as claimed in claim 13, wherein an item of context information from the multiplicity of items of context information is representative of an item of information relating to weather in a vicinity of the vehicle.

22. The method as claimed in claim 13, wherein a first usage scenario from the predefined multiplicity of usage scenarios includes one or more recommendations pertaining to one or more software applications of the vehicle.

23. The method as claimed in claim 22, wherein a recommendation pertaining to a software application of the vehicle of the first usage scenario from the predefined multiplicity of usage scenarios is representative of frequencies with which users, of a fleet of vehicles of a vehicle manufacturer operate software applications.

24. The method as claimed in claim 13, wherein the determined usage scenario of the vehicle is linked to a confidence interval, wherein the confidence interval indicates a certainty with which the usage scenario has been determined in dependence on the frequency with which the user of the vehicle operates the software application and on the multiplicity of items of context information of the vehicle; and
wherein the proactive recommendation message of the digital assistant is provided to the driver of the vehicle only if a lower limit of the confidence interval of the determined usage scenario exceeds a minimum confidence threshold.

25. The method as claimed in claim 24, wherein the proactive recommendation message includes the determined usage scenario and the confidence interval of the determined usage scenario.

26. The method as claimed in claim 13, wherein the proactive recommendation message includes one or a plurality of recommendations pertaining to one or more software applications of the determined usage scenario.

27. A non-transitory computer-readable medium comprises instructions that, when executed on a computer, perform the method as claimed in claim 13.

28. A system for providing a proactive recommendation message of a digital assistant of a vehicle to a driver of the vehicle, wherein the system is configured to perform the method as claimed in claim 13.

29. A vehicle comprising the system, as claimed in claim 28, for providing a proactive recommendation message of a digital assistant of a vehicle to a driver of the vehicle.
